(19) United States
(12) Patent Application Publication
(10) Pub. No.: US 2004/0139650 A1
(43) Pub. Date: Jul. 22, 2004

(54) Automatic portable watering system for indoors plant

(76) Inventor: Ataul Haq, Alexandria, VA (US)

Correspondence Address: ATAUL HAQ, # 1412, 5340 HOLMES RUN PKWY, ALEXANDRIA, VA, 22304, US

(21) Appl. No.: 10/755,407

(22) Filed: Jan. 13, 2004

Related U.S. Application Data
(60) Provisional application No. 60/439,438, filed on Jan. 13, 2003.

(51) Int. Cl. A01G 29/00

(52) U.S. Cl. 47/48.5

(57) ABSTRACT

An automatic watering system for indoors plants which operates on moisture sensitive substance like crystal gel. The moisture sensitive substance deforms due to the absorption of moisture in the soil and in turn operates a valve by a mechanical, electrical or chemical arrangement. The operation of the valve allows the water to flow out of a controlled water chamber in response to dry condition of the soil. The water flow stops as the moisture content reaches a certain level in the soil. This automatic watering system is ideal for plants and shrubs unattended for a extended period of time. This automatic watering system is portable and completely integrated. Optional attachments can make the system good for several plant-pots and straight filling from any household faucet.

### CROSS REFERENCE TO THE RELATED APPLICATION

This application claims the benefit of U.S. Provisional Patent Application Serial No. 60/439,438, filed Jan. 13, 2003.

### BACKGROUND OF THE INVENTION

This present invention relates to an automatic portable moisture sensitive indoor plant watering system. This simple and yet economical watering system is portable and fully self-contained. This watering system operates on the moisture condition of the plant soil on which it is placed/installed. This unique design and simple operation makes this invention very useful, economical and very easy to install. This system can be a stand-alone system or can be hook-up with household faucet if the owner is absent for a long period of time. Yet another feature of this invention is that it can be connected to several pots, which would receive water depending on the soil condition of the master pot.

### DESCRIPTION OF RELATED ART

Several inventions have been done so far but not a single invention relates the operation of the discharge of water based on the moisture content of the soil. Several prior arts been examined, such as, Mount, et, al. U.S. Pat. No. 6,401,389; Reiss, et al U.S. Pat. No. 6,370,819; Rummins U.S. Pat. No. 5,502,594.

### SUMMARY OF THE INVENTION

This automatic moisture sensitive indoor plant watering system that can be left unattended for an extended period of days, weeks and even months, works on deformation of moisture sensitive substance contained in an integrated spike. This perforated spike penetrates the soil upon installation and senses the moisture condition of the soil. This automatic watering system does not require any external or internal power for operation. The system is fully contained and reliable, which operated on physical, electrical or chemical deformation of the moisture sensitive substance. The deformation of the substance actuates a valve that opens up during dry condition of soil, thereby letting a controlled flow of water on the soil surface. During the state of moisture saturation in the soil, the deformation of the substance cause the valve to close thereby prevents the water to the surface of the soil.

This unit is also equipped with secondary filling mechanism via a overfill float check valve integrated in the main water tank, enabling the system to be connected to the household water supply. Furthermore, this unit is also provided with several discharge connectors, which when connected can supply water to several plants based on the soil condition of the master pot. The system is provided with a primary flow control valve, which has several setting to control the total controlled irrigation.

### BRIEF DESCRIPTION OF THE DRAWING

FIG. 1 explains across section of the art showing components and component assemblies.

1. Filling inlet and cap

2. Main water tank

3. Mounting arrangement and clamp

4. Moisture sensitive spike

5. Valve stem assembly; mechanical, electrical, chemical or combination thereof.

6. Discharge valve assembly; mechanical, electrical or combination thereof

7. Flow control valve stem assembly

8. Additional ports for connecting to other pots

9. Main flow control valve

10. Plant pot

11. Moisture sensitive substance; crystal gel, ceramic media, electromagnetic substance, or other material capable of similar function.

12. Household faucet connecting inlet

13. Main tank overfill check valve assembly

14. Main tank overfill float assembly

15. Secondary holding tank

16. Water discharge spout

17. Spring arrangement and assembly

### DETAIL DESCRIPTION OF PREFFERED EMBODIMENT

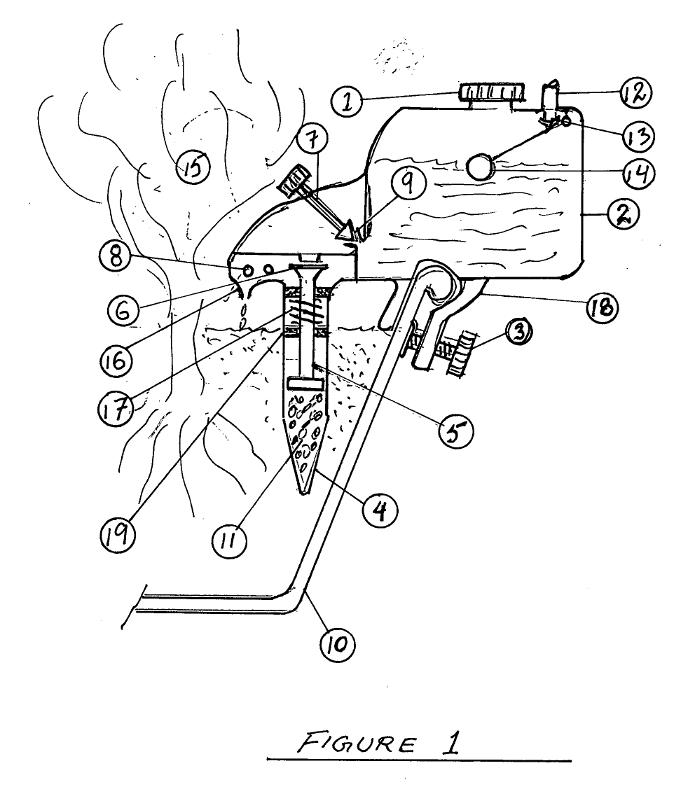

1. As best illustrated in the attached drawing sheet, this automatic portable watering system for indoor plants comprises, but not limited to, 19 components as described in the attached drawing FIG. 1.

2. The present invention is a portable automatic watering system for indoor plants. This automatic watering system is fully self contained and integrated and does not require any external or internal power supply. This watering system is integrated with a reasonable size water tank (2) made in a curved profile and mounting legs (18) along with a adjusting/gripping hand turn screw (3) which can be easily mounted on rim of standard plant pot.

3. This automatic watering system is integrated with a perforated spike (4), which penetrates the soil upon installation. The tip of this spike is filled with moisture sensitive substance (11), which expands fairly rapidly due to the absorption of moisture in the soil or shrinks rapidly due to the absence of moisture in the soil. Moisture sensitive substance like crystal gel, ceramic media, electromagnetic substance, electro-conducting substance or other material capable of similar function can be used.

4. A simple mechanical plunger mechanism (5) or electromechanical combination system, which moves according to the mechanical, electrical, chemical or electro-magnetic deformation of the moisture sensitive substance.

5. The spring-loaded plunger (17) operates a valve (6) through a watertight seal (19) in order to open or close the water flow from the holding tank (15) in to the discharge spout (16). This valve can be mechanical, electrical or combination thereof.

6. A mechanical valve stem assembly (7) having several settings operates a differential valve (9) in order to control the total water available for irrigation into the holding tank. The main water tank (2) is fitted with a filling cap (1) and a secondary filling inlet (12). A float (14) and a overfill check valve assembly (13) is also integrated into the main water tank.

7. The secondary water tank known as holding tank (15) is equipped with several secondary ports (8) in order to provide controlled flow to other pots if connected to this master water system.

I claim:

1. An automatic portable plant watering system sensitive to the soil moisture of a plant pot which can be connected to household faucet into the main tank having overfill float valve check system, which having a controlled flow of water into the holding tank via manually controlled valve, which discharge water for irrigation through a discharge spout into the soil surface controlled by a sealed valve system operated by a mechanism stimulated by a moisture sensitive material contained in a perforated spike which is sub-soiled during installation of the system on the rim of a plant pot.

2. The moisture sensitive perforated spike based on above claim 1 is filled with substance, which undergoes physical, chemical, magnetic or electrical changes due to the presence or absence of moisture in the adjacent soil.

3. The sealed valve system based on claim 1 is a mechanical, electrical or electro-mechanical valve that is actuated by the moisture sensitive substance in turn operates a valve to open and close position in order to let flow or block water flow from the holding tank into the discharge sprout.

4. The holding tank based on claim 1 is integrated with and is separated from the main tank via a flow control valve having several settings, which is also fitted with several discharge ports which can be fitted with attachments to supply water to other pots, which is also integrated with a discharge spout.

5. Overfill float controlled valve assembly based on claim 1 is integrated in the main tank which is alternatively fitted with a secondary filling connector to be connected to any household water faucet for filling purpose, which is also provided with a filling opening and cap.
